(19) United States
(12) Patent Application Publication
(10) Pub. No.: US 2025/0036417 A1
(43) Pub. Date: Jan. 30, 2025

(54) UNIFIED ENDPOINT MANAGEMENT PLATFORM FOR APPLICATION LIFECYCLE MANAGEMENT

(71) Applicant: Omnissa, LLC, Mountain View, CA (US)

(72) Inventors: SRIHARSHA APPRAMEYA, Bangalore (IN); SIVA PRAVEEN MUMMANENI, Bangalore (IN); SURESH LAKKALA, Bangalore (IN); ADITYA ULMAN, Bangalore (IN); GAURAV GUPTA, Bangalore (IN)

(21) Appl. No.: 18/381,667

(22) Filed: Oct. 19, 2023

(30) Foreign Application Priority Data
Jul. 24, 2023 (IN) 202341049628

(51) Int. Cl. G06F 9/38; G06F 8/65

(52) U.S. Cl. CPC G06F 9/3836; G06F 8/65

(57) ABSTRACT

Aspects of the disclosure enable endpoint devices to launch applications from an application inventory data store using a unified endpoint management (UEM) platform. The UEM platform obtains an application specification from the application inventory data store, wherein the application specification includes a group of applications and includes location data associated with the group of applications on the application inventory data store. The UEM platform receives user data from an endpoint device that indicates a user is enrolled with the UEM platform and the UEM platform provides the application specification data to the endpoint device. The UEM platform determines a subset of applications of the group of applications that are assigned to the user using the user data and provides the determined subset of the applications to the endpoint device, whereby the endpoint device is enabled to launch an application of the subset of applications using the application specification data.

### RELATED APPLICATIONS

Benefit is claimed under 35 U.S.C. 119 (a)-(d) to Foreign application No. 202341049628 filed in India entitled “A UNIFIED ENDPOINT MANAGEMENT PLATFORM FOR APPLICATION LIFECYCLE MANAGEMENT”, on Jul. 24, 2023, by VMware, Inc., which is herein incorporated in its entirety by reference for all purposes.

### BACKGROUND

Central hubs enable a wide range of applications to be launched and executed in the cloud or otherwise using distributed computing devices. However, such systems present challenges with respect to compatibility of a wide variety of applications, lifecycle management of those applications, and controlling access to those applications by a wide variety of users.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for enabling endpoint devices to launch applications from an application inventory data store using a unified endpoint management (UEM) platform is described. The UEM platform obtains application specification data from the application inventory data store, wherein the application specification data identifies a group of applications and includes location data associated with the group of applications on the application inventory data store. The UEM platform receives user data from an endpoint device that indicates a user is enrolled with the UEM platform and the UEM platform provides the application specification data to the endpoint device. The UEM platform determines a subset of applications of the group of applications that are assigned to the user using the user data and provides the determined subset of the applications to the endpoint device, whereby the endpoint device is enabled to launch an application of the subset of applications using the location data of the application specification data.

### BRIEF DESCRIPTION OF THE DRAWINGS

The present description will be better understood from the following detailed description read considering the accompanying drawings, wherein:

FIG. 1 is a block diagram illustrating an example system configured to enable endpoint devices to access applications in an application inventory data store;

FIG. 2 is a sequence diagram illustrating an example process for launching applications using a unified endpoint management (UEM) platform;

FIG. 3 is a sequence diagram illustrating an example process for launching applications on-demand using a UEM platform;

FIG. 4 is a flowchart illustrating an example method performed by a UEM platform to enable the launching of applications from an application inventory data store;

FIG. 5 is a flowchart illustrating an example method performed by an endpoint device to launch applications from an application inventory data store;

FIG. 6 illustrates an example computing apparatus as a functional block diagram;
and

FIG. 7 is a block diagram illustrating an endpoint device graphical user interface (GUI) configured to display an application catalog and enable a user to launch applications using the displayed application catalog.

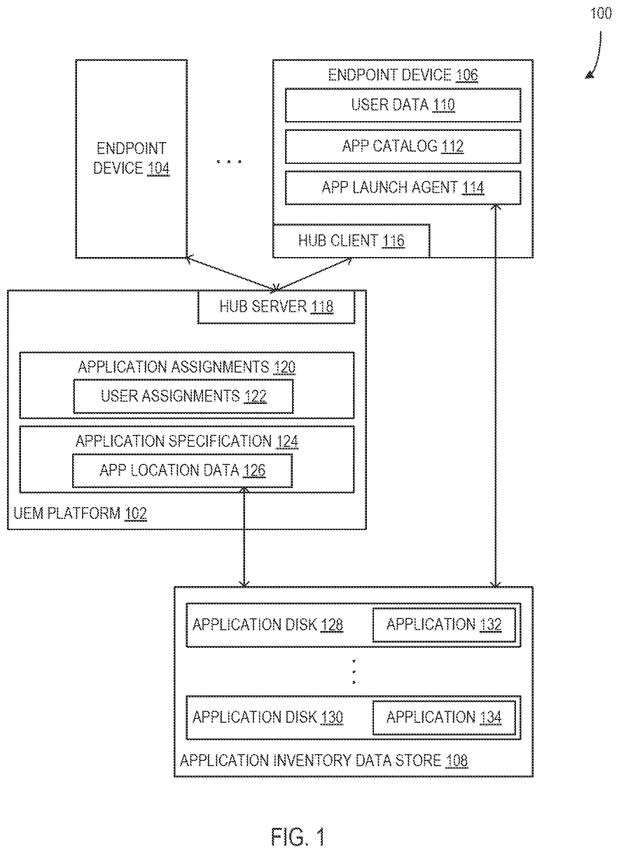

Corresponding reference characters indicate corresponding parts throughout the drawings. In FIGS. 1 to 7, the systems are illustrated as schematic drawings. The drawings may not be to scale. Any of the figures may be combined into a single example or embodiment.

### DETAILED DESCRIPTION

Aspects of the disclosure provide systems and/or methods for enabling the launch of a wide variety of different applications from an application inventory data store by endpoint devices connected to that data store. The described UEM platform maintains application specification data associated with the applications that can be launched from the application inventory data store and provides that application specification data to endpoint devices. The application specification data provides the endpoint devices with information indicating where the applications are located in the application inventory data store and/or information enabling the endpoint devices to otherwise launch and interact with applications in the application inventory data store. Further, the UEM platform controls access to the applications through the maintenance of application assignments, which assign specific applications to specific users or groups of users. In most examples, applications that are assigned to a user can be launched by that user, while applications that are not assigned to the user or a group of users to which the user belongs cannot be launched by that user. Thus, the UEM platform initializes endpoint devices to enable the endpoint devices to effectively launch and use applications on the application inventory data store. Additionally, or alternatively, the UEM platform enables efficient management of the lifecycles of applications through sharing updated application specification data with endpoint devices and other processes as described herein.

The disclosure operates in an unconventional manner at least by reducing time and resource costs associated with using different platforms for diverse types of applications. The described UEM platform maintains a comprehensive set of application specification data that enables a wide variety of different applications to be accessed from within a single system. This application specification data, when shared with endpoint devices, enables those endpoint devices to perform operations that are compatible with all the applications that are offered by such a system.

Further, the disclosure reduces the complexity of, and computing resource costs associated with, distributing different versions of applications to multiple parties during the lifecycle of those applications. A new version of an application can be installed to the application inventory data store and updated application specification data is provided to the UEM platform. Then, the UEM platform can send the updated application specification data to endpoint devices as needed, eliminating the need for endpoint devices to install any additional updates in response to version changes. In particular, updating the file paths or other identifying data associated with a version of an application that is up to date can be done seamlessly from the perspective of endpoint devices in that the file path or other identifying data of the previous version is swapped out for the file path or other identifying data of the new version in the application specification data, which is shared with the endpoint devices.

Additionally, the disclosure reduces the consumption of data storage space of application data by centralizing storage in the application inventory data store, thus eliminating redundancy. The endpoint devices are enabled to launch the applications from the data locations in the application inventory data store while minimizing the quantity of data of those applications that must be downloaded and/or otherwise stored in the endpoint devices.

FIG. 1 is a block diagram illustrating an example system 100 configured to enable endpoint devices 104-106 to access applications 132-134, or apps, in an application inventory data store 108. In some examples, a unified endpoint management (UEM) platform 102 is configured to maintain an application specification 124 associated with the application inventory data store 108 and to store application assignments 120 associated with users or user accounts. Further, the UEM platform 102 is configured to be accessed by endpoint devices 104-106 via connections between the hub server 118 and hub client 116 and to provide those endpoint devices 104-106 with application location data 126 for use in populating an application catalog 112 and in launching applications by an application launch agent 114. Additionally, or alternatively, the UEM platform 102 filters, limits, or otherwise controls the applications that an endpoint device 106 can access based on user assignments 122 that are linked to user data 110 of a user that is signed in to or otherwise using the endpoint device 106.

In some examples, the endpoint devices 104-106 are configured to interact with the UEM platform 102 and/or the application inventory data store 108 using one or more agent processes. In some such examples, an endpoint device 106 includes a UEM platform agent that is configured to enable user interactions with the UEM platform and the hub client 116 that enables user interaction with the hub server 118 as described herein. Further, in some such examples, the same client software plays the role of both the UEM platform agent and the hub client 116 while, in other examples, the UEM platform agent and hub client 116 are separate. Additionally, or alternatively, in some such examples, an endpoint device 106 can remain connected to the UEM platform 102 through at least two routes, including through the hub client 116 and the hub server 118 to the UEM platform 102 and through a separate UEM agent to the UEM platform.

Further, in some examples, the system 100 includes one or more computing devices (e.g., the computing apparatus of FIG. 6) that are configured to communicate with each other via one or more communication networks (e.g., an intranet, the Internet, a cellular network, other wireless network, other wired network, or the like). In some examples, entities of the system 100 are configured to be distributed between the multiple computing devices and to communicate with each other via network connections. For example, the UEM platform 102 is executed on a first computing device and the application inventory data store 108 is located on one or more other computing devices within the system 100. The first computing device and other computing devices are configured to communicate with each other via network connections. Alternatively, in some examples, components of the UEM platform 102 (e.g., the hub server 118 and the stored application specification 124 and/or application assignments 120) are executed or otherwise located on separate computing devices and those separate computing devices are configured to communicate with each other via network connections during the operation of the system 100. In other examples, other organizations of computing devices are used to implement system 100 without departing from the description. For example, each endpoint device 104-106 is a separate device that communicates with a device associated with the UEM platform 102 and/or a device associated with the application inventory data store 108.

The application inventory data store 108 includes hardware, firmware, and/or software configured to store and provide access to applications 132-134 on application disks 128-130. In some examples, the application inventory data store 108 is a repository of all the applications that can be executed by endpoint devices 104-106 using the system 100. The applications 132-134 of the application inventory data store 108 are software applications with code, files, and/or other data stored on the application disks 128-130 in the application inventory data store 108 that can be executed in a virtualized manner at the endpoint devices 104-106. For example, a user of the endpoint device 106 selects to execute application 132 from application disk 128 on the endpoint device 106. Through the processes described herein, the endpoint device 106 is configured to treat the location of the application 132 within the application disk 128 as if it were a local file location in the endpoint device 106 and to execute the application 132 as it if it were locally installed using the app launch agent 114. It should be understood that, in some such examples, the location information associated with the application 132 includes data other than a specific file path, which is then mapped to the correct location in the application inventory data store 108, when necessary, as described herein. Thus, the location of the application 132 can be used by the endpoint device 106 as an equivalent local file location without a specific file path through the described mapping.

Application disks 128-130 include hardware, firmware, and/or software configured for storing applications 132-134 and associated data in the application inventory data store 108. In some examples, the application disks 128-130 include physical and/or virtualized data storage disks that store the data of the applications 132-134 and the application inventory data store 108 further includes metadata associated with the locations of the applications 132-134 on the application disks 128-130. Additionally, or alternatively, the metadata includes application lifecycle data, such as version information for an instance of an application, indicators that indicate whether an application instance is the most up-to-date version of that application, or the like. For example, the application inventory data store 108 stores multiple versions of the application 132 that can be executed and, for one of the versions, an indicator that shows that the version is the most up-to-date version of that application 132. In some such examples, attempting to execute the application 132 defaults to using the most up-to-date version, but if a special request is made for a specific version, that requested version can be executed instead, even if it is not the most up-to-date version of the application 132.

In some examples, the application disks 128-130 include one or more layers of virtual address spaces that map to each other and/or a physical address space that is associated with physical application disks 128-130. In some such examples, the layers of indirect references are used to efficiently enable the lifecycle management of applications 132-134. In an example, a first address references a virtual entry of the application 132 in a first layer and a second address in that virtual entry references a first physical location of that application 132. When a new version of the application 132 is installed at a second physical location, the second address of the virtual entry in the first layer can be updated to reference the second physical location without altering the first address of the virtual entry of the application 132. Thus, the application 132 can be updated without significantly changing how that application 132 is accessed. For example, the application 132 is updated without notifying all accessing applications or entities that the address of the application 132 has changed.

The UEM platform 102 includes hardware, firmware, and/or software that is configured to communicate with endpoint devices 104-106, obtain and/or maintain application specification 124 associated with the application inventory data store 108, and enable users of endpoint devices 104-106 to access applications 132-134 that they have been assigned using application assignments 120. Additionally, or alternatively, the UEM platform 102 enables administrators or the like to manage the assignments of applications to users and/or to otherwise manage changes in the lifecycles of applications 132-134 of the application inventory data store 108.

In some examples, the UEM platform 102 includes a hub server 118 that is configured to be a communication interface between the endpoint devices 106 and the UEM platform 102. The hub server 118 is configured to receive requests or other information from the endpoint devices 106 and to send information to the endpoint devices 106, such as in response to requests. For example, the hub server 118 sends assigned application information in response to a load catalog request from a user of the endpoint device 106. Further, in some examples, the endpoint devices 104-106 include hub clients 116 which correspond to the hub server 118 and are configured to enable the communication between the endpoint devices 104-106 and the UEM platform 102 as described herein. Additionally, or alternatively, in some examples, some endpoint devices 104-106 include UEM platform agents that enable the endpoint devices to communicate with the UEM platform 102 while bypassing the hub server 118 and hub clients 116.

Further, the UEM platform 102 maintains and/or uses application assignments 120 during its operations. In some examples, the application assignments 120 are defined to indicate the entities that can access the applications 132-134 in the application inventory data store 108. In many cases, the application assignments 120 are user assignments 122, which indicate which applications 132-134 are assigned to a user or user account. However, in other examples, application assignments 120 are defined for other entities, such as roles or groups of users/user-groups. For example, a user associated with a role has access to the applications assigned to that role. Still further, in some examples, application assignments 120 include assignments to other entities that are not associated with users, such as assignments of applications to specific endpoint devices or groups of endpoint devices. Such application assignments 120 are also combined in some examples, such as the assignment of an application to a specific user or users when using a specific endpoint device. Additionally, or alternatively, in an example, one or more endpoint devices associated with a user are assigned a subset of applications, while remaining devices associated with the same user are assigned another subset of applications. One or more endpoint devices associated with the same user in such examples have zero or more assigned applications in common. It should be understood that, in other examples, application assignments 120 are made to other entities and/or types of entities without departing from the description.

In an example, applications A, B, and C are assigned to a user X. The user assignments 122 of user X includes references to each of the applications A, B, and C. In some such examples, the references to the applications include identifiers of the applications and/or version information associated with the applications that are assigned to user X. It should be understood that, in some examples, the application assignments 120 include a list or other grouping of reference pairs, with each reference pair including an identifier of an assignee (e.g., a user or other entity to which the application is assigned) and an identifier of an application 132-134. In other examples, other data structures are used to contain the application assignments 120 and/or more or different data is used to define the application assignments 120 without departing from the description.

In some examples, the UEM platform 102 stores and maintains an application specification 124 which includes app location data 126 that is ingested or otherwise obtained from the application inventory data store 108. In some examples, the application specification 124 includes file paths to disk locations for the applications 132-134 that are referenced by the application specification 124. For example, the application specification 124 includes entries for applications 132-134 and each entry includes an identifier of an application and a file path to the location of that application within the application inventory data store 108. In other examples, more and/or different information is included in the application specification (e.g., version information for applications). In other examples, the application specification 124 includes other data associated with the applications 132-134 that is used to access the applications 132-134 in the application inventory data store 108 in addition to or instead of the described file path data. For instance, in an example, the application specification 124 includes a data entry associated with an application that maps to a location of the application within the application inventory data store 108 (e.g., an identifier of the application that is provided to the application inventory data store 108 and used therein to determine the location of the associated application within the application inventory data store 108 via a mapping between the identifier and location data of the application).

Additionally, or alternatively, the application specification 124 includes application compatibility data for each application that enables endpoint devices to be configured to be compatible with the applications when launching them as described herein. For example, the compatibility data of an application includes information describing one or more interfaces of the application that enable software, such as the operating system (OS), of the launching endpoint device to interact with the application during its launch and/or execution.

Further, in some examples, the application specification 124 that is provided to endpoint devices 104-106 is filtered to prevent application specification data associated with apps that are not assigned to a current user or endpoint device from being provided. Thus, in such examples, the UEM platform 102 first determines the applications that are assigned to the current user and/or endpoint device and then uses that determination to send only application specification data associated with the assigned applications to the endpoint device.

The endpoint devices 104-106 include hardware, firmware, and/or software configured to communicate with the UEM platform 102 and to launch and execute applications 132-134 from the application inventory data store 108 as described herein. Further, the endpoint devices 104-106 enable users to sign in, providing user data 110, such that applications offered to the user at the endpoint device 106 are filtered to include those applications that have been assigned to that user.

In some examples, user data 110 includes a username or other identifier and/or other login credentials such as a password or personal identification number (PIN). It should be understood that, in some examples, the endpoint device 106 does not store the user login credentials, but instead, collects them from the user and provides them to the UEM platform 102 for authentication. Further, in some examples, the endpoint device 106 directs the user to an identity provider entity for authentication with the UEM platform 102. Thus, while the user data 110 is illustrated as being within the endpoint device 106, in most examples, the endpoint device 106 does not store or maintain login credentials of a user, such as passwords or PINs. Additionally, or alternatively, user data 110 includes a user account identifier that is used by the system 100 to uniquely identify the user among other users of the system 100. Other user data 110 includes roles or other user groups with which a user is associated, user-specific preference or setting data associated with executed applications 132-134, or the like. Additionally, in some examples, the endpoint device 106 includes endpoint device-specific data that is used with or instead of the user data 110 to determine application assignments 120 and/or to obtain the app catalog 112 as described herein.

The app catalog 112 includes a data structure that stores application information associated with applications 132-134 that are assigned to a current user of the endpoint device 106 and/or applications 132-134 that are accessible to all users of the endpoint device 106 (e.g., applications that are assigned to the endpoint device 106 specifically, rather than assigned to users). In some examples, the app catalog 112 includes a list of application identifiers of those included applications 132-134. Further, in some examples, the app catalog 112 is displayed or otherwise provided to a user via a user interface (UI) that enables a user to select applications that are to be launched from the applications 132-134 of the application inventory data store 108. For example, the app catalog 112 is displayed on a screen UI to a user as a list or grid of application names and/or icons, whereby the user is enabled to select one or more of the displayed applications for launch and execution. In some other examples, the app catalog 112 that is displayed to a user via a UI is also embedded within the hub client 116 itself and displayed to the user in that way.

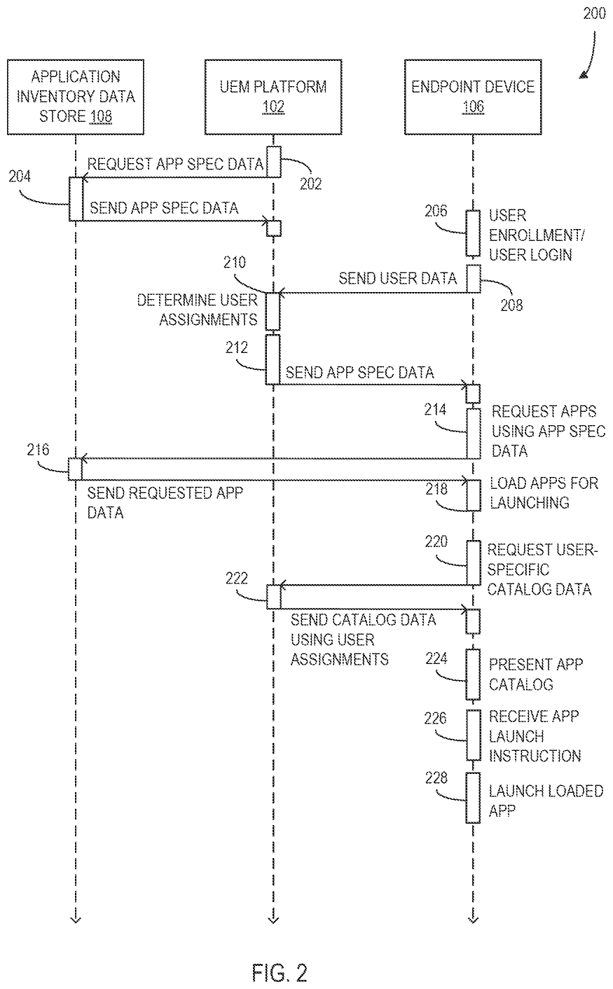

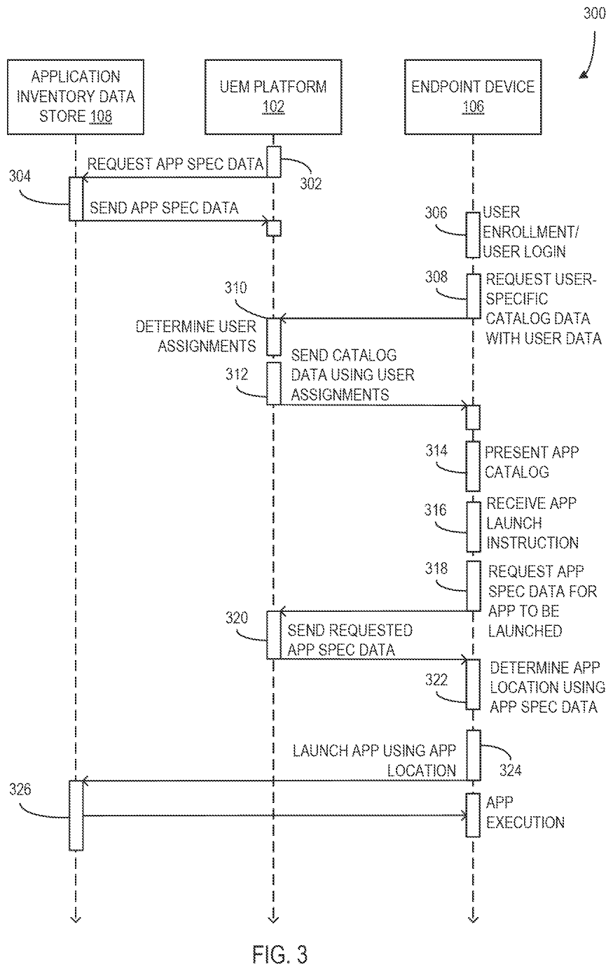

The app launch agent 114 is configured to receive instructions from a user to launch one or more applications 132-134. Further, the app launch agent 114 is configured to use the application specification 124 to connect to the application inventory data store 108, access data associated with the one or more applications 132-134 using the app location data 126 of the application specification 124, and launch those accessed applications, which can then be used by the user of the endpoint device 106. In some examples, the app launch agent 114 is provided the application specification 124 by the UEM platform 102 during the interactions between the endpoint device 106 and the UEM platform 102. These processes are described in greater detail at least with respect to FIGS. 2-3.

In some examples, the system 100 is configured to enable lifecycle management of the applications 132-134 in the application inventory data store 108. Such lifecycle management includes enabling new and/or different versions of applications to be deployed in the application inventory data store 108 and then launched by users of endpoint devices 104-106. In some examples, applications can be deployed or otherwise placed in the application inventory data store 108 at different points in the lifecycle of the applications. For instance, a new version of an application can be deployed to the application inventory data store 108 as a “test version” that can only be accessed by a few users for testing purposes while an older version of the same application remains deployed to the application inventory data store 108 for general use as a “production version”. The distributed nature of the system 100 enables users, such as testers of a test version of an application, to access the test version of the application from any endpoint device 104-106, so long as the user has been assigned access to the test version of the application.

Additionally, or alternatively, when a new version of an application is deployed for general use as a production version to the application inventory data store 108, the application specification 124 is updated as necessary with respect to the new version of the application such that endpoint devices 104-106 that try to launch the application are enabled to launch the most up-to-date version of the application without any additional configuration steps by the user.

In other examples, applications that must be removed, such as applications that are found to have security vulnerabilities, can be removed from the application inventory data store 108 and thus protect all of the endpoint devices 104-106 from any issues with the removed applications. Similarly, brand new applications can be deployed to the application inventory data store 108 and, after the application specification 124 is updated in the UEM platform 102 and any application assignments 120 are defined, that new application is available to users at any of the endpoint devices 104-106 as described herein.

Further, in some examples, the UEM platform 102 is configured to obtain the app location data 126 and/or other data of the application specification 124 from the application inventory data store 108 periodically and/or based on the occurrence of events. For example, the UEM platform 102 is configured to obtain the application specification 124 from the application inventory data store 108 at least once per day (e.g., every day at midnight). Further, in some examples, the UEM platform 102 frequently determines whether the application specification 124 of the application inventory data store 108 has changed since it was last obtained and, if so, the UEM platform 102 obtains updated data for the application specification 124 (e.g., every 30 minutes). Additionally, or alternatively, the application inventory data store 108 is configured to record or log changes and/or to notify the UEM platform 102 when changes occur. The UEM platform 102 then, in response to those notifications, obtains the updated data for the application specification 124. The updated data may include the entire application specification 124 or only the portions that have changed since the last update obtained by the UEM platform 102. It should be understood that, in some examples, the UEM platform 102 is configured to have a maximum frequency at which it updates the application specification 124 so as not to inefficiently use processing and/or network resources associated with the UEM platform 102 and/or application inventory data store 108.

In some examples, the system 100 is configured to enable administrators to configure and/or define application assignments 120 and/or how application assignments 120 are created or changed. In some examples, administrators manually define assignments of applications to users, groups of users, roles, or the like. Additionally, or alternatively, application developers classify applications 132-134 into categories and application assignments 120 are automatically generated based on those categories. For example, a test version of an application is only assigned to users that are in a tester role, a new customer service application is automatically assigned to users in customer service roles. In some examples, users can request access to an application, category of applications, or other group of applications. Such requests are evaluated by administrators and/or other entities associated with the system and granted or rejected. In other examples, other features of applications are used to automatically generate application assignments 120 and/or affect the generation of application assignments 120. For example, an application is developed to access data that requires users to have a certain security clearance. As a result of accessing this data, the automatically generated application assignments 120 associated with the new application are limited to users that have the security clearance.

FIG. 2 is a sequence diagram illustrating an example process 200 for launching applications (e.g., applications 132-134) using the UEM platform 102. In some examples, the process 200 is executed or otherwise performed in a system such as system 100 of FIG. 1.

At 202, the UEM platform 102 requests application specification (app spec) data from the application inventory data store 108 and, at 204, the application inventory data store 108 sends the requested app spec data to the UEM platform 102. In some examples, the requested app spec data includes app location data 126 that is used by the UEM platform 102 to manage the application specification 124 that is used throughout the process. Further, in some examples, the request for app spec data by the UEM platform 102 is triggered or caused based on a schedule and/or an event as described herein. Alternatively, or additionally, the application inventory data store 108 is configured to send app spec data to the UEM platform 102 without receiving a request. For example, a change to the data in the application inventory data store 108 triggers an automatic sending of updated app spec data to the UEM platform 102.

Further, it should be understood that the ingestion or obtaining of app spec data by the UEM platform 102 can occur at other times during the process 200 to keep the app spec data in the UEM platform 102 up to date without departing from the description.

At 206, a user enrollment and/or user login occurs at the endpoint device 106. In some examples, the user enrollment or login includes a user providing user data to the endpoint device 106 that is used to authenticate the identity of the user and/or associate the user with a user account that can be used to access applications using the UEM platform 102 and application inventory data store 108 as described herein.

At 208, the endpoint device 106 sends the user data obtained during the user enrollment/login to the UEM platform 102 and, at 210, the UEM platform 102 determines user assignments 122 associated with the provided user data. In some examples, the user assignments include data value pairs, wherein a data value pair includes a user identifier and an application identifier of an application that has been assigned to the user. Thus, in some examples, the UEM platform 102 identifies the data value pairs that include the user identifier of the user and generates a list or group of applications that have been assigned to that user using the identified data value pairs.

At 212, the UEM platform 102 sends app spec data to the endpoint device 106 in response to the sent user data. In some examples, the sent user data indicates to the UEM platform 102 that the endpoint device 106 will be used to access applications associated with the app spec data and, as a result, the UEM platform 102 sends the app spec data to enable the endpoint device 106 to prepare for launching of applications in the near future. In some such examples, the app spec data is pushed to an app launch agent 114 of the endpoint device 106, which then communicates with the application inventory data store 108 to prepare for launching associated applications in the near future. Further, in some examples, the app spec data includes application identifiers and associated app file path locations or other types of location data that point to, or otherwise reference via mapping, the data locations within the application inventory data store 108 (e.g., data locations on application disks 128-130). In some examples, the app spec data sent to the endpoint device 106 includes app spec data associated only with the applications that are assigned to the user based on the sent user data. Thus, the app spec data is filtered to prevent security issues associated with providing the endpoint device 106 app spec data for applications that are not assigned to the current user.

At 214, the endpoint device 106 requests apps from the application inventory data store 108 using the app spec data received from the UEM platform 102. At 216, the requested app data is sent from the application inventory data store 108 to the endpoint device 106 and, at 218, the apps associated with the sent app data are loaded by the endpoint device 106 for later launching. In some examples, an app launch agent 114 of the endpoint device 106 is configured to perform operations associated with 214-218 as described herein.

At 220, the endpoint device 106 requests user-specific catalog data from the UEM platform 102 and, in response to the request, at 222, the UEM platform 102 sends catalog data to the endpoint device 106 using the determined user assignments. In some examples, the catalog data includes the list or group of applications that have been assigned to the user that is logged in to the endpoint device 106.

At 224, the endpoint device 106 presents an application catalog, or app catalog, to the user of the endpoint device 106. In some examples, presenting the application catalog includes displaying a group of applications on a UI of the endpoint device and enabling the user to select or otherwise interact with visual representations of the applications. Alternatively, or additionally, the application catalog is presented to the user using other methods without departing from the description, such as presenting a list of application names in a text-based interface.

At 226, the endpoint device 106 receives a launch instruction from the user. In some examples, the launch instruction is initiated by a user selecting one of the applications in the presented application catalog, such as the user clicking on or otherwise activating an icon associated with the application being launched.

At 228, the app associated with the app launch instruction is launched. Because the apps were prefetched and loaded previously at 214-218, the endpoint device 106 launches the app using the loaded app data (e.g., via interactions with an app launch agent 114).

FIG. 3 is a sequence diagram illustrating an example process 300 for launching applications (e.g., applications 132-134) on-demand using the UEM platform 102. In some examples, the process 300 is executed or otherwise performed in a system such as system 100 of FIG. 1.

At 302, the UEM platform 102 requests application specification (app spec) data from the application inventory data store 108 and, at 304, the application inventory data store 108 sends the requested app spec data to the UEM platform 102. In some examples, the requested app spec data includes app location data 126 that is used by the UEM platform 102 to manage the application specification 124 that is used throughout the process. Further, in some examples, the request for app spec data by the UEM platform 102 is triggered or caused based on a schedule and/or an event as described herein. Alternatively, or additionally, the application inventory data store 108 is configured to send app spec data to the UEM platform 102 without receiving a request. For example, a change to the data in the application inventory data store 108 triggers an automatic sending of updated app spec data to the UEM platform 102.

Further, it should be understood that the ingestion or obtaining of app spec data by the UEM platform 102 can occur at other times during the process 300 to keep the app spec data in the UEM platform 102 up to date without departing from the description.

At 306, a user enrollment and/or user login occurs at the endpoint device 106. In some examples, the user enrollment or login includes a user providing user data to the endpoint device 106 that is used to authenticate the identity of the user and/or associate the user with a user account that can be used to access applications using the UEM platform 102 and application inventory data store 108 as described herein.

At 308, the endpoint device 106 sends a request for user-specific catalog data, including the user data obtained during the user enrollment/login to the UEM platform 102 in the request. At 310, the UEM platform 102 determines user assignments 122 associated with the provided user data. In some examples, the user assignments include data value pairs, wherein a data value pair includes a user identifier and an application identifier of an application that has been assigned to the user. Thus, in some examples, the UEM platform 102 identifies the data value pairs that include the user identifier of the user and generates a list or group of applications that have been assigned to that user using the identified data value pairs.

At 312, the UEM platform 102 sends catalog data to the endpoint device 106 using the determined user assignments. In some examples, the catalog data includes the list or group of applications that have been assigned to the user that is logged in to the endpoint device 106.

At 314, the endpoint device 106 presents an application catalog to the user of the endpoint device 106. In some examples, presenting the application catalog includes displaying a group of applications on a UI of the endpoint device and enabling the user to select or otherwise interact with visual representations of the applications. Alternatively, or additionally, the application catalog is presented to the user using other methods without departing from the description (e.g., presenting a list of application names in a text-based interface).

At 316, the endpoint device 106 receives a launch instruction from the user. In some examples, the launch instruction is initiated by a user selecting one of the applications in the presented application catalog. For example, the user clicks on or otherwise activates an icon associated with the application being launched.

At 318, the endpoint device 106 sends a request to the UEM platform 102 for the app spec data associated with the application to be launched. At 320, the UEM platform 102 sends the requested app spec data of that application to the endpoint device 106 in response to the request. In this way, the process 300 differs from the process 200. The app spec data of the application to be launched is obtained from the UEM platform 102 on-demand, rather than obtaining all of the application data from the UEM platform 102 and application inventory data store 108 at the beginning of the process.

Thus, the process 300 requires fewer initializing steps prior to presenting a user-specific application catalog to the user of the endpoint device 106, but the trade-off is that launching applications requires (i) an additional interaction with the UEM platform 102 to obtain the app spec data and (ii) another additional interaction with application inventory data store 108 to fetch other app data required for the launch. In contrast, in process 200, the app spec data is pushed to the endpoint device 106 by the UEM platform 102 even before the user tries to launch an application from the application catalog. Additionally, the endpoint device 106 may fetch all necessary app data from the application inventory data store 108 even before the user tries to launch an application from the application catalog.

These differences between processes 200 and 300 motivate systems to be configured to perform one or the other based on system resource use, network traffic implications, or other considerations. Further, in some examples, hybrid processes that mix processes 200 and 300 are used, such that some of the app spec data is obtained upon the endpoint device 106 initially connecting with the UEM platform 102 while other app spec data is only requested when an associated application is launched on the endpoint device 106.

At 322, the location of the application to be launched is determined by the endpoint device 106 using the app spec data provided by the UEM platform 102 and, at 324, the application is launched using the application in the application inventory data store 108. In some examples, launching the application includes the endpoint device 106 establishing a network connection with the application inventory data store 108 and providing the location of the application to an interface of the application inventory data store 108. The endpoint device 106 is then enabled to launch and execute the application at 326 using the established network connection to download data associated with the application to the endpoint device 106 and/or to otherwise interact with the data of the application in the application inventory data store 108.

In some examples, it is the app launch agent 114 running on the endpoint device 106 which knows how to parse the application specification data, determine the location of the application from the app spec data and communicate with the application inventory data store 108 to download necessary data and launch the specified application.

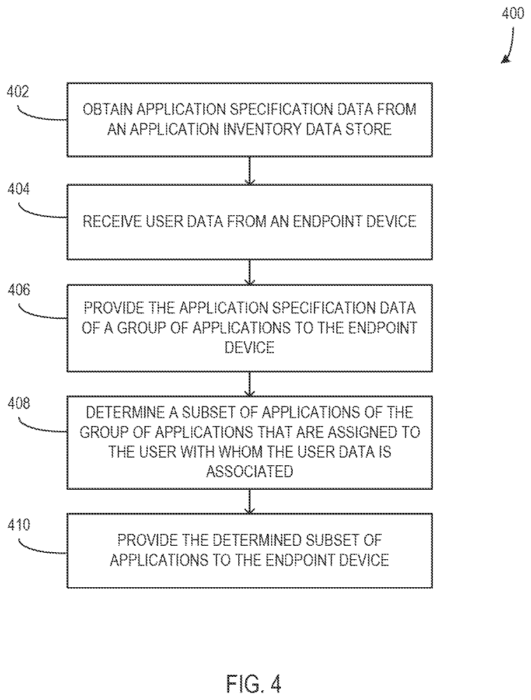

FIG. 4 is a flowchart illustrating an example method 400 performed by a UEM platform (e.g., UEM platform 102) to enable the launching of applications (e.g., applications 132-134) from an application inventory data store (e.g., application inventory data store 108). In some examples, the method 400 is executed or otherwise performed in a system such as system 100 of FIG. 1.

At 402, application specification data is obtained from an application inventory data store by the UEM platform. In some examples, the application specification data includes application location data such as file paths that reference data locations in the disks (e.g., application disks 128-130) of the application inventory data store and that are associated with the applications that are located in those data locations. Further, in some examples, the UEM platform obtains the application specification data by requesting it from the application inventory data store, while in other examples, the application inventory data store sends the application specification data to the UEM platform without a request being received. For example, the UEM platform subscribes to receive notifications about updated application specification data from the application inventory data store and based on that subscription, the application inventory data store sends updated application specification data to the UEM platform via notifications. Alternatively, the application inventory data store notifies the subscribed UEM platform of application specification changes and, in response to the notification, the UEM platform requests the updated application specification from the application inventory data store.

Additionally, or alternatively, the UEM platform obtains application specification data from the application inventory data store repeatedly over time. For example, the UEM platform obtains application specification data periodically based on a defined schedule. Alternatively, or additionally, the UEM platform obtains application specification from the application inventory data store based on the occurrence of an event, such as one or more entries of the application specification data being updated in the application inventory data store and the application inventory data store sending updated application specification data to the UEM platform in response to those updates.

At 404, the UEM platform receives user data from an endpoint device. In some examples, the user data identifies a user that is using the endpoint device. Further, the user data includes an indicator that the user has recently enrolled to use the UEM platform and/or an indicator that the user has recently logged in to the endpoint device to make use of the UEM platform and associated applications. Additionally, in some examples, the receipt of the user data indicates to the UEM platform that the endpoint device will be used to launch applications from the application inventory data store in the near future, so it triggers the UEM platform to initialize the endpoint device for that use.

At 406, UEM platform provides the application specification data of a group of applications to the endpoint device. In some examples, the application specification data includes data that identifies the applications that are available in the application inventory data store and location data associated with those applications in the application inventory data store. Further, in some examples, the UEM platform sends the application specification data for some or all of the applications to the endpoint device upon receiving the user data from the endpoint device in order to initialize the endpoint device to be able to launch any of those applications referenced in the sent application specification data. Alternatively, or additionally, the UEM platform sends application specification data associated with a specific application in response to a request from the endpoint device as part of the process of the endpoint device launching that specific application (e.g., see 314-320 of the process 300 of FIG. 3). In other examples, other methods of the UEM platform sending application specification data are used without departing from the description. For example, the UEM platform determines the user assignments of the user of the endpoint device based on the user data and then sends application specification data associated with only those applications that are assigned to the user to initialize the endpoint device.

At 408, the UEM platform determines a subset of applications of the group of applications that are assigned to the user with whom the user data is associated. In some examples, the UEM platform determines the user assignments of the user by identifying entries in the application assignments (e.g., application assignments 120) that are associated with an identifier of the user. Additionally, or alternatively, the UEM platform determines applications that are assigned to the user based on groups that the user is a part of and/or roles with which the user is associated. In such examples, the UEM platform determines a group or role of the user from the user data and then identifies entries in the application assignments associated with the determined group or role, such that the assigned applications of the user include any applications assigned to the determined group or role. In other examples, the assigned applications of the user are determined in other ways without departing from the description.

At 410, the UEM platform provides the determined subset of applications to the endpoint device. In some examples, by providing the subset of applications to the endpoint device, the UEM platform is enabling the endpoint device to present the available applications to the user and to launch an application of the subset of applications using a disk file path, or another type of identifying data or location data, of the application specification data.

It should be understood that, in some examples, the UEM platform performs method 400 in association with a plurality of different endpoint devices and different users simultaneously or at substantially the same time. For example, the providing of application specification data to a first endpoint device is performed at the same time as determining a subset of applications assigned to a user of a second endpoint device.

Further, in some examples, as the UEM platform obtains updated application specification data, it provides that updated application specification data to any endpoint devices that are currently active and/or connected to the UEM platform (e.g., endpoint devices with users who are logged in). Thus, the UEM platform provides each endpoint device with up-to-date application specification data, enabling those endpoint devices to seamlessly launch applications from the application inventory data store without additional steps to upgrade, patch, or otherwise alter the applications prior to launch.

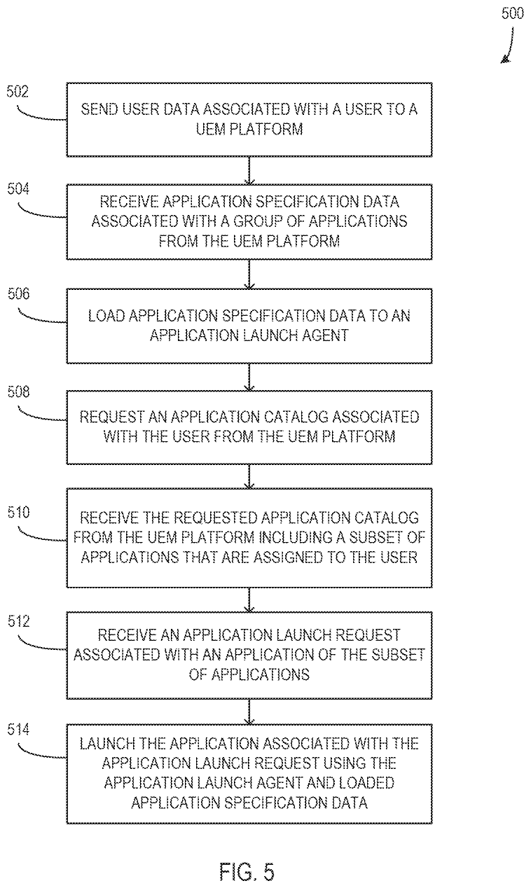

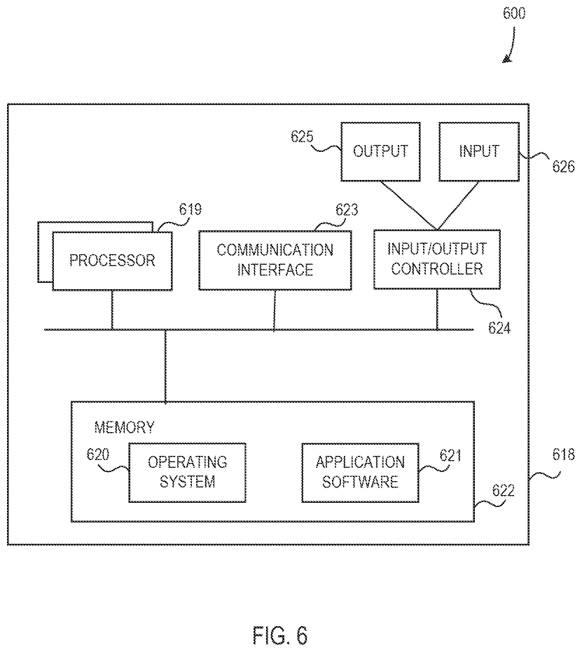

FIG. 5 is a flowchart illustrating an example method 500 performed by an endpoint device (e.g., endpoint device 106) to launch applications (e.g., applications 132-134) from an application inventory data store (e.g., application inventory data store 108). In some examples, the method 500 is executed or otherwise performed in a system such as system 100 of FIG. 1.

At 502, the endpoint device sends user data associated with a user to the UEM platform. In some examples, the user data is provided to the endpoint device by the user through an interface of the endpoint device and the user data includes an identifier of the user and/or credentials that verify the identity of the user (e.g., a username and password). Further, in some examples, the user data includes data indicating user groups or roles with which the user is associated. The endpoint device forwards the received user data to the UEM platform to establish a connection with the UEM platform and/or the application inventory data store that the user can use to launch assigned applications as described herein.

At 504, the endpoint device receives application specification data associated with a group of applications from the UEM platform and, at 506, the endpoint device loads the application specification data to an application launch agent (e.g., application launch agent 114). In some examples, the application launch agent records or stores the application specification data and responds to launch requests by connecting with the application inventory data store using the stored application specification data as described herein. Further, in some examples, the application launch agent is configured to use application compatibility data in the application specification data to interact with the applications when launching or otherwise executing them, as described herein.

At 508, the endpoint device requests an application catalog associated with the user from the UEM platform. In some examples, the request for the application catalog occurs at the same time as or before the loading of the application specification data to the application launch agent. Alternatively, in some examples, user data is sent to the UEM platform as described above at 502 with a request for the application catalog, such that 508 occurs during 502. In other examples, other methods or combinations of steps are performed to request the application catalog without departing from the description.

At 510, the endpoint device receives the requested application catalog from the UEM platform, including a subset of applications that are assigned to the user. In some examples, the endpoint device presents the application catalog to the user, enabling the user to select an application to be launched as described herein.

At 512, the endpoint device receives an application launch request associated with an application of the subset of applications. In some examples, the application launch request is based on an application of the application catalog that is selected for launch by the user of the endpoint device. Alternatively, or additionally, the application launch request is generated by another process of the endpoint device. Further, the application launch request includes an identifier of the application to be launched.

At 514, the endpoint device launches the application associated with the application launch request using the application launch agent and the loaded application specification data. In some examples, the application launch agent forms a network connection between the endpoint device and the application inventory data store. The application launch agent then launches the application over the network connection using the location data of the application that is present in the application specification data, as described herein. Alternatively, in other examples, the application associated with the application launch request has already been prefetched and loaded by an application launch agent (e.g., as described above with respect to FIG. 2), such that the endpoint device launches the application using the prefetched and loaded app data.

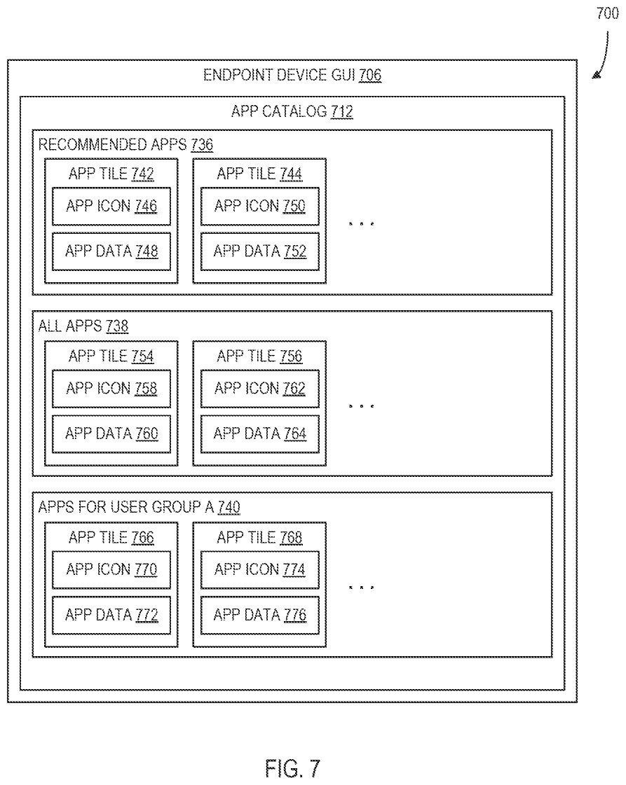

FIG. 7 is a block diagram 700 illustrating an endpoint device graphical user interface (GUI) 706 configured to display an application catalog 712 and enable a user to launch applications using the displayed application catalog 712. In some examples, the endpoint device GUI 706 is displayed by an endpoint device in a system such as system 100 of FIG. 1.

The endpoint device GUI 706 displays the application catalog, or app catalog 712 to the user, including a plurality of app tiles associated with apps that can be launched by the user. Further, in some examples, the app catalog 712 displays the app tiles in groups or categories based on a variety of different features of those apps.

As illustrated, the app catalog 712 includes various categories such as a recommended apps section 736, an all apps section 738, and an apps for user group A section 740. When the user logs into the endpoint device, the user sees only the apps to which the user is entitled or assigned, no matter which category (e.g., the recommended apps section 736, the all apps section 738, the apps for user group A section 740, or other categories).

In some examples, the app catalog 712 of the user contains the all apps section 738 that includes all apps that are available to the current user. There are some examples where the app catalog 712 does not contain the all apps section 738, such as when the user does not have any apps assigned. Additionally, in some examples, an administrator configures the end user experience of the app catalog 712 by including one or more optional sections such as the recommended apps section 736, the apps for user group A section 740, etc. If the administrator does not include one or more of the optional sections while configuring the end user experience of the app catalog 712, then those optional sections will not appear in the app catalog 712. If the administrator includes one or more of the optional sections while configuring the end user experience of the app catalog 712, then those optional sections will appear in the app catalog 712 only if the user has one or more app assignments that belong to that specific section.

The recommended apps section 736 displays app tiles 742 and 744. App tile 742 displays an app icon 746 indicative of the app with which the app tile 742 is associated and app data 748 that provides some additional details or context for the associated app. Similarly, app tile 744 includes an app icon 750 and app data 752. In some examples, the app data displayed for the apps in the app tiles includes an indicator of the source of the app if the endpoint device is connected to multiple application inventory data store, an indicator of a version of the app, an indication of a last time the current user launched the app, and/or other types of information. Further, in some examples, the recommended apps section 736 is configured to include apps that the current user has used frequently and/or recently. In other examples, other methods are used to determine which apps are recommended to the current user without departing from the description. For example, the recommended apps section 736 is configured to include apps that are recommended to the user by others, such as the administrator and/or other users). The recommended apps section 736 may also be titled as a frequently used apps section or a recently used apps section, in some examples, based on the configured content of the recommended apps section 736.

The all apps section 738 is configured to include all apps that are available to the current user. As illustrated, the all apps section 738 includes app tiles 754 and 756. The app tile 754 includes an app icon 758 and app data 760. The app tile 756 includes an app icon 762 and app data 764. In some examples, the all apps section 738 also includes the apps that are displayed in the recommended apps section 736 and the apps for user group A 740 because the all apps section 738 is configured to display all available apps that are assigned or otherwise available to the current user.

The apps for user group A section 740 is configured to include apps that are available to the current user and that are assigned a user group A of which the current user is a member. In some such examples, it is useful to the current user to see how the available apps are assigned (e.g., a current task assigned to the user is associated with user group A and the app for completing the current task is assigned to the user group A). As illustrated, the apps for user group A section 740 includes app tiles 766 and 768. The app tile 766 includes an app icon 770 and app data 772. The app tile 768 includes an app icon 774 and app data 776.

It should be understood that, in other examples, the app catalog 712 displays more, fewer, and/or different apps without departing from the description. Further, in other examples, the app catalog 712 displays the apps in more, fewer, or different sections without departing from the description.

The endpoint device GUI 706 is configured to enable the current user to click on or otherwise activate an app tile in order to request that the associated app be launched from the application inventory data store as described herein. For instance, in some examples, the display of the endpoint device GUI 706 is performed as 218 of FIGS. 2 and/or 314 of FIG. 3. Further, in some such examples, the endpoint device GUI 706 is populated with the app catalog 712 as a result of the endpoint device receiving catalog data from a UEM platform such as UEM platform 102 as described herein.

### Example Operating Environment

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hard-coded machine. In some examples, platform software comprising an operating system 620 or any other suitable platform software is provided on the apparatus 618 to enable application software 621 to be executed on the device. In some examples, launching and executing applications from an application inventory data store using a UEM platform as described herein is accomplished by software, hardware, and/or firmware.

In some examples, computer executable instructions are provided using any computer-readable media that is accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Propagated signals per se are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receives output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: obtain, by a UEM platform, application specification data from an application inventory data store; receive, by the UEM platform, user data from an endpoint device, wherein the user data indicates that a user is enrolled with the UEM platform; provide, by the UEM platform, the application specification data to the endpoint device, wherein the application specification data includes a group of applications and location data referencing locations in the application inventory data store associated with applications of the group of applications; determine, by the UEM platform, a subset of applications of the group of applications that are assigned to the user with which the user data is associated; and provide, by the UEM platform, the determined subset of applications to the endpoint device, whereby the endpoint device is enabled to launch an application of the subset of applications using the location data of the application specification data.

An example computerized method comprises obtaining, by a UEM platform, application specification data from an application inventory data store; receiving, by the UEM platform, user data from an endpoint device, wherein the user data indicates that a user is enrolled with the UEM platform; providing, by the UEM platform, the application specification data to the endpoint device, wherein the application specification data includes a group of applications and location data referencing locations in the application inventory data store associated with applications of the group of applications; determining, by the UEM platform, a subset of applications of the group of applications that are assigned to the user with which the user data is associated; and providing, by the UEM platform, the determined subset of applications to the endpoint device, whereby the endpoint device is enabled to launch an application of the subset of applications using the location data of the application specification data.

One or more computer storage media have computer-executable instructions that, upon execution by a processor, cause the processor to at least: obtain, by a UEM platform, application specification data from an application inventory data store; receive, by the UEM platform, user data from an endpoint device, wherein the user data indicates that a user is enrolled with the UEM platform; provide, by the UEM platform, the application specification data to the endpoint device, wherein the application specification data includes a group of applications and location data referencing locations in the application inventory data store associated with applications of the group of applications; determine, by the UEM platform, a subset of applications of the group of applications that are assigned to the user with which the user data is associated; and provide, by the UEM platform, the determined subset of applications to the endpoint device, whereby the endpoint device is enabled to launch an application of the subset of applications using the location data of the application specification data.

Alternatively, or in addition to the other examples described herein, examples include any combination of the following:
further comprising: receiving, by the UEM platform, an application specification data request from the endpoint device, the application specification data request including an application identifier of an application of the determined subset of applications; and wherein providing the application specification data to the endpoint device includes providing, to the endpoint device, application specification data associated with the application identifier included in the application specification data request in response to the application specification data request.
further comprising: obtaining, by the UEM platform, updated application specification data including updated location data of the application associated with the application identifier included in the application specification data request from the endpoint device; receiving, by the UEM platform, another application specification data request from the endpoint device, the other application specification data request including the application identifier of the application of the determined subset of applications; and providing, by the UEM platform, the updated location data of the application associated with the application identifier to the endpoint device in response to the other application specification data request.
further comprising: obtaining, by the UEM platform, updated application specification data from the application inventory data store; determining, by the UEM platform, that the endpoint device is connected to the UEM platform; and providing the updated application specification data to the endpoint device in response to determining that the endpoint device is connected to the UEM platform.
wherein obtaining the application specification data from the application inventory data store includes: periodically sending, by the UEM platform, a request for updated application specification data; and receiving, by the UEM platform, the application specification data in response to the periodically sent request.
wherein obtaining the application specification data from the application inventory data store includes: subscribing, by the UEM platform, to receive notifications from the application inventory data store associated with application specification data changes; and receiving, by the UEM platform, the application specification data in a notification from the application inventory data store based on the subscribing.
wherein determining the subset of applications of the group of applications that are assigned to the user with which the user data is associated includes: identifying entries in a user assignment data structure that include a user identifier from the user data; and determining applications that are assigned to the user using the identified entries.
wherein determining the subset of applications of the group of applications that are assigned to the user with which the user data is associated includes: identifying a user group of the user using the user data; identifying entries in a user assignment data structure that include the identified user group of the user; and determining applications that are assigned to the user using the identified entries.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for obtaining, by a UEM platform, application specification data from an application inventory data store; exemplary means for receiving, by the UEM platform, user data from an endpoint device, wherein the user data indicates that a user is enrolled with the UEM platform; exemplary means for providing, by the UEM platform, the application specification data to the endpoint device, wherein the application specification data includes a group of applications and location data referencing locations in the application inventory data store associated with applications of the group of applications; exemplary means for determining, by the UEM platform, a subset of applications of the group of applications that are assigned to the user with which the user data is associated; and exemplary means for providing, by the UEM platform, the determined subset of applications to the endpoint device, whereby the endpoint device is enabled to launch an application of the subset of applications using the location data of the application specification data.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
obtain, by a unified endpoint management (UEM) platform, application specification data from an application inventory data store;
receive, by the UEM platform, user data from an endpoint device, wherein the user data indicates that a user is enrolled with the UEM platform;
provide, by the UEM platform, the application specification data to the endpoint device, wherein the application specification data includes a group of applications and location data referencing locations in the application inventory data store associated with applications of the group of applications;
determine, by the UEM platform, a subset of applications of the group of applications that are assigned to the user with which the user data is associated; and
provide, by the UEM platform, the determined subset of applications to the endpoint device, whereby the endpoint device is enabled to launch an application of the subset of applications using the location data of the application specification data.

2. The system of claim 1, wherein the memory and the computer program code are configured to cause the processor to:
receive, by the UEM platform, an application specification data request from the endpoint device, the application specification data request including an application identifier of the application of the determined subset of applications; and
wherein providing the application specification data to the endpoint device includes providing, to the endpoint device, application specification data associated with the application identifier included in the application specification data request in response to the application specification data request.

3. The system of claim 2, wherein the memory and the computer program code configured to cause the processor to:
obtain, by the UEM platform, updated application specification data including updated location data of the application associated with the application identifier included in the application specification data request from the endpoint device;
receive, by the UEM platform, another application specification data request from the endpoint device, the other application specification data request including the application identifier of the application of the subset of applications; and
provide, by the UEM platform, the updated location data of the application associated with the application identifier to the endpoint device in response to the other application specification data request.

4. The system of claim 1, wherein the memory and the computer program code configured to cause the processor to:
obtain, by the UEM platform, updated application specification data from the application inventory data store;
determine, by the UEM platform, that the endpoint device is connected to the UEM platform; and
provide the updated application specification data to the endpoint device in response to determining that the endpoint device is connected to the UEM platform.

5. The system of claim 1, wherein obtaining the application specification data from the application inventory data store includes:
periodically sending, by the UEM platform, a request for updated application specification data; and
receiving, by the UEM platform, the application specification data in response to the periodically sent request.

6. The system of claim 1, wherein obtaining the application specification data from the application inventory data store includes:
subscribing, by the UEM platform, to receive notifications from the application inventory data store associated with application specification data changes; and
receiving, by the UEM platform, the application specification data in a notification from the application inventory data store based on the subscribing.

7. The system of claim 1, wherein determining the subset of applications of the group of applications that are assigned to the user with which the user data is associated includes:
identifying entries in a user assignment data structure that include a user identifier from the user data; and
determining that the subset of applications includes applications that are assigned to the user using the identified entries.

8. The system of claim 1, wherein determining the subset of applications of the group of applications that are assigned to the user with which the user data is associated includes:
identifying a user group of the user using the user data;
identifying entries in a user assignment data structure that include the identified user group of the user; and
determining that the subset of applications includes applications that are assigned to the user using the identified entries.

9. A computerized method comprising:
obtaining, by a unified endpoint management (UEM) platform, application specification data from an application inventory data store;
receiving, by the UEM platform, user data from an endpoint device, wherein the user data indicates that a user is enrolled with the UEM platform;
providing, by the UEM platform, the application specification data to the endpoint device, wherein the application specification data includes a group of applications and location data referencing locations in the application inventory data store associated with applications of the group of applications;
determining, by the UEM platform, a subset of applications of the group of applications that are assigned to the user with which the user data is associated; and
providing, by the UEM platform, the determined subset of applications to the endpoint device, whereby the endpoint device is enabled to launch an application of the subset of applications using the location data of the application specification data.

10. The computerized method of claim 9, further comprising:
receiving, by the UEM platform, an application specification data request from the endpoint device, the application specification data request including an application identifier of the application of the subset of applications; and
wherein providing the application specification data to the endpoint device includes providing, to the endpoint device, application specification data associated with the application identifier included in the application specification data request in response to the application specification data request.

11. The computerized method of claim 10, further comprising:
obtaining, by the UEM platform, updated application specification data including updated location data of the application associated with the application identifier included in the application specification data request from the endpoint device;
receiving, by the UEM platform, another application specification data request from the endpoint device, the other application specification data request including the application identifier of the application of the subset of applications; and
providing, by the UEM platform, the updated location data of the application associated with the application identifier to the endpoint device in response to the other application specification data request.

12. The computerized method of claim 9, further comprising:
obtaining, by the UEM platform, updated application specification data from the application inventory data store;
determining, by the UEM platform, that the endpoint device is connected to the UEM platform; and
providing the updated application specification data to the endpoint device in response to determining that the endpoint device is connected to the UEM platform.

13. The computerized method of claim 9, wherein obtaining the application specification data from the application inventory data store includes:
periodically sending, by the UEM platform, a request for updated application specification data; and
receiving, by the UEM platform, the application specification data in response to the periodically sent request.

14. The computerized method of claim 9, wherein obtaining the application specification data from the application inventory data store includes:
subscribing, by the UEM platform, to receive notifications from the application inventory data store associated with application specification data changes; and
receiving, by the UEM platform, an application specification change notification from the application inventory data store based on the subscribing; and
obtaining, by the UEM platform, updated application specification data from the application inventory data store based on the received application specification change notification.

15. The computerized method of claim 9, wherein determining the subset of applications of the group of applications that are assigned to the user with which the user data is associated includes:
identifying entries in an application assignment data structure that include an endpoint device identifier of the endpoint device; and
determining that the subset of applications includes applications that are assigned to the endpoint device using the identified entries.

16. The computerized method of claim 9, wherein determining the subset of applications of the group of applications that are assigned to the user with which the user data is associated includes:
identifying a user group of the user using the user data;
identifying entries in a user assignment data structure that include the identified user group of the user; and
determining that the subset of applications includes applications that are assigned to the user using the identified entries.

17. A computer storage medium storing computer-executable instructions that, upon execution by a processor, cause the processor to at least:
obtain, by a unified endpoint management (UEM) platform, application specification data from an application inventory data store;
receive, by the UEM platform, user data from an endpoint device, wherein the user data indicates that a user is enrolled with the UEM platform;
provide, by the UEM platform, the application specification data to the endpoint device, wherein the application specification data includes a group of applications and location data referencing locations in the application inventory data store associated with applications of the group of applications;
determine, by the UEM platform, a subset of applications of the group of applications that are assigned to the user with which the user data is associated; and
provide, by the UEM platform, the determined subset of applications to the endpoint device, whereby the endpoint device is enabled to launch an application of the subset of applications using the location data of the application specification data.

18. The computer storage medium of claim 17, wherein the computer-executable instructions, upon execution by the processor, further cause the processor to at least:
receive, by the UEM platform, an application specification data request from the endpoint device, the application specification data request including an application identifier of the application of the subset of applications; and
wherein providing the application specification data to the endpoint device includes providing, to the endpoint device, application specification data associated with the application identifier included in the application specification data request in response to the application specification data request.

19. The computer storage medium of claim 18, wherein the computer-executable instructions, upon execution by the processor, further cause the processor to at least:
obtain, by the UEM platform, updated application specification data including updated location data of the application associated with the application identifier included in the application specification data request from the endpoint device;
receive, by the UEM platform, another application specification data request from the endpoint device, the other application specification data request including the application identifier of the application of the subset of applications; and
provide, by the UEM platform, the updated location data of the application associated with the application identifier to the endpoint device in response to the other application specification data request.

20. The computer storage medium of claim 17, wherein the computer-executable instructions, upon execution by the processor, further cause the processor to at least:
obtain, by the UEM platform, updated application specification data from the application inventory data store;
determine, by the UEM platform, that the endpoint device is connected to the UEM platform; and
provide the updated application specification data to the endpoint device in response to determining that the endpoint device is connected to the UEM platform.
